(19) United States
(12) Patent Application Publication
(10) Pub. No.: US 2018/0163412 A1
(43) Pub. Date: Jun. 14, 2018

(54) Two-Layer Composite Wood Floor Board

(71) Applicant: LinYi Maocheng Home Furnishing Co. Ltd., Linyi City (CN)

(72) Inventor: Liren Qiao, Shanghai Province (CN)

(21) Appl. No.: 15/614,224

(22) Filed: Jun. 5, 2017

(30) Foreign Application Priority Data
Dec. 12, 2016 (CN) 201611140324.0
Dec. 12, 2016 (CN) 201621362140.4

(51) Int. Cl. E04F 15/04; E04F 15/02; B32B 7/12; B32B 21/13

(52) U.S. Cl. CPC E04F 15/045; E04F 15/02038; B32B 7/12; B32B 21/13; B32B 2419/00; E04F 2201/023; E04F 2201/043; E04F 2203/08; E04F 2201/0107

(57) ABSTRACT

The present invention discloses a two-layer composite wood floor board, comprising a face plate and a base plate, wherein the face plate is disposed above the base plate, the face plate is glued to the base plate, the base plate is formed by peeling a log, the lower part of the base plate is provided with more than one grooves, and reinforcing ribs are disposed in part or all of the grooves. The present invention has the following advantageous effects: on one hand, the area of a single base material formed by peeling is larger so that the number of gluing is reduced for manufacturing a floor board having the same area, thereby greatly reducing adhesive consumption, and meanwhile, the increase of the outturn percentage of the log and the simplification of the machining process are achieved by manufacturing the base plate through peeling, thereby greatly improving the production efficiency.

### CROSS REFERENCE TO RELATED APPLICATION

This application claims the benefit of and takes priority from Chinese Patent Application Serial No. 201611140324.0 filed on Dec. 12, 2016 and Chinese Patent Application Serial No. 201621362140.4 filed on Dec. 12, 2016, the contents of which are herein incorporated by reference.

### TECHNICAL FIELD

The present invention relates to the field of wood floor boards, and in particular to a two-layer composite wood floor board.

### BACKGROUND ART

Wood floor boards mainly includes a single-layer pure solid wood floor board, a multi-layer composite wood floor board, a laminate wood floor board, a cork floor board and a bamboo floor board, where the multi-layer composite wood floor board is often divided into two-layer, three-layer and multi-layer composite wood floor boards. The two-layer composite wood floor board is typically formed by bonding a face material and a base material by using an adhesive. At present, a face plate material for the two-layer wood floor board on the market is mostly made by sawing, slicing and peeling a log, a base plate material is typically formed by bonding wood strips sawn from the log with an adhesive. This two-layer floor board needs a lot of adhesive since the base plate material is formed by gluing and splicing the wood strips. Meanwhile, the elasticity and rigidity of such two-layer floor board are not easy to control. Moreover, with the sawing process to produce the wood strips for the base plate, the outturn percentage is low, the process is complex and cumbersome, and the production efficiency is low.

CN 202945781 U discloses a two-layer solid wood composite floor board with a toothless frame-type substrate, where the two-layer solid wood composite floor board with the toothless frame-type substrate has a toothless solid wood frame as a substrate, and the frame-type substrate is formed by sandwiching one cross grain core material between two longitudinal grain edgings, pressurizing and gluing by making the grains mutually vertical to a toothless plane to form a base material, and gluing a face material layer on the base material. The two-layer solid wood composite floor board with the toothless frame-type substrate has the comprehensive advantages of the pure solid wood floor board and the multi-layer composite wood floor board, is good in anti-deformation performance and moisture absorption performance, but has the disadvantage of high adhesive consumption.

### SUMMARY OF THE INVENTION

To solve the technical problem of high adhesive consumption for the composite floor board, the present invention provides a two-layer composite solid wood floor board and a production method thereof, with the objects of reducing the adhesive consumption while increasing the outturn percentage, simplifying the production process and improving the production efficiency.

To achieve the above objects, the present invention provides a technical solution as follows:

a two-layer composite wood floor board comprises a face plate and a base plate, wherein the face plate is disposed above the base plate and connected with the base plate via gluing, and the base plate is formed by peeling a log.

For the two-layer composite wood floor board described above, preferably, the thickness of the face plate is less than that of the base plate, the thickness of the face plate is 1 mm to 6 mm and the thickness of the base plate is 9 mm to 13 mm.

For the two-layer composite wood floor board described above, preferably, the lower part of the base plate is provided with more than one grooves.

For the two-layer composite wood floor board described above, preferably, the reinforcing ribs are disposed in part or all of the grooves.

For the two-layer composite wood floor board described above, preferably, the lower surface of each reinforcing rib is not lower than the lower surface of the base plate.

For the two-layer composite wood floor board described above, preferably, when the number of the grooves is two or more, the grooves are arranged in parallel with one another, a spacing between the two adjacent grooves is 5 mm to 20 mm, and each groove has a width of 10 mm to 50 mm and a depth of 2 mm to 8 mm.

For the two-layer composite wood floor board described above, preferably, the face plate has a wood fiber direction vertical to a wood fiber direction of the base plate.

For the two-layer composite wood floor board described above, preferably, the periphery of the floor board is provided with male tenons or female slots, and the two adjacent floor boards are spliced by the male tenons and female slots.

To implement the technical solution described above, the present invention provides a production method of the two-layer composite wood floor board as described above. A production method of a two-layer composite wood floor board is implemented according to the following steps:

a. two processed logs are chosen;

b. one log is preferably oak, maple, black walnut, hickory, stained wood or birch to serve as a material for a face plate, and the other log is preferably pine, poplar or fir to serve as a material for a base plate;

c. the material for the face plate is peeled, sawn or sliced into a plate having the thickness of 1 mm to 6 mm, and the material for the base plate is peeled into a plate having the thickness of 9 mm to 13 mm;

d. the lower part of the base plate is grooved with a grooving machine to obtain more than one grooves, wherein when more than two grooves are machined, the grooves are arranged in parallel with each other, a spacing between the two adjacent grooves is 5 mm to 20 mm, the grooves are preferably rectangular grooves with the width of 10 mm to 50 mm and the depth of 2 mm to 8 mm;

e. reinforcing ribs matching the grooves in shape and size are prepared, wherein the reinforcing ribs are preferably selected from birch or maple;

f. the face plate and the base plate are glued and fixed using an adhesive, wherein a texture direction of the base plate is vertical to that of the face plate;

g. the reinforcing ribs and the grooves are fixedly connected, preferably in an inlaid connection manner and a gluing connection manner,

h. the lower surface of each reinforcing rib is not lower than, and preferably is flush with, the lower surface of the base plate; and

i. male tenons or female slots are machined at two ends and two sides of the two-layer composite floor board to obtain the two-layer composite wood floor board.

The present invention provides a two-layer composite wood floor board, which has the following advantageous effects: on one hand, a plate with the thickness of 9 mm to 13 mm produced by peeling with a peeling machine is used as a base material for the floor board, the area of the single base material is larger so that the gluing number is reduced for manufacturing the floor board having the same area, thereby greatly reducing the adhesive consumption, and meanwhile, the outturn percentage of the log is increased by manufacturing the base plate through peeling, thereby increasing the utilization ratio of the log to greatly improve the production efficiency; and on the other hand, the lower part of the base plate is provided with the grooves, the reinforcing ribs made from a raw material with high toughness are matched with the grooves at the lower part of the base plate, the strength and rigidity of the two-layer composite wood floor board are controlled by means of the number, width, depth and distribution on the base plate, of the reinforcing ribs, and meanwhile, the internal stress of the wood is dispersed by grooving the base plate to thereby limit the deformation of the floor board.

### BRIEF DESCRIPTION OF THE DRAWINGS

To more clearly illustrate the technical solution in an embodiment of the present disclosure or in the prior art, drawings required to be used in the description of the embodiment or the prior art will be briefly introduced in the following. It is obvious that the drawings described in the following are only related to some embodiments of the present invention. Other drawings may be obtained according to these drawings by those ordinarily skilled in the art without making inventive efforts.

FIG. 1 is a structural schematic diagram of a longitudinal section of a two-layer composite wooden floor board provided by the present invention,

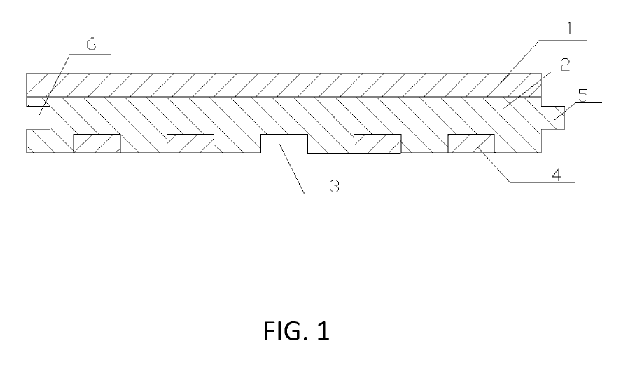

In FIG. 1, reference signs are as follows: 1. face plate, 2. base plate; 3. groove; 4. reinforced rib; 5. male tenon; 6. female slot.

### DETAILED DESCRIPTION OF THE PREFERRED EMBODIMENTS

The present invention is further illustrated below through embodiments. Experimental data from the following embodiments are shown in Table 1, wherein adhesive consumption (g/m2) is used to characterize how much adhesive is consumed in the floor board production, and the smaller the value, the fewer adhesive is used for producing certain area of floor board; static bending intensity (MPa) is used to characterize the pressure intensity which the floor board is capable of bearing at the point of bending to fracture under force, the larger the value, the higher the pressure intensity which the floor board is capable of bearing; and elastic modulus (MPa) is used to characterize the difficulty level at which the floor board deforms elastically, the higher the value, the larger the rigidity of the floor board, that is, the elastic deformation is smaller under the action of certain stress. The data in Table 1 are the means of results obtained when the floor board is manufactured according to the method in each embodiment and then 10 groups of samples are chosen for each floor board. The embodiments as described are only part of, rather than all of, the embodiment of the present invention. All those other embodiments obtained by those ordinarily skilled in the art based on the embodiments in the present invention without making any inventive efforts are construed to fall within the protection scope of the present invention.

As shown in FIG. 1, the two-layer composite wood floor board provided by the present invention consists of a face plate 1 and a base plate 2; a material for the base plate is formed with a peeling method and has a larger area, so that the gluing number is reduced in case of preparing the floor board having the same area, thereby reducing the consumption of the adhesive; the lower part of the base plate 2 is provided with the grooves 3, reinforcing ribs 4 are disposed in all or part of the grooves, the strength and rigidity of the floor board can be controlled by the matching between the grooves and the reinforcing ribs, and meanwhile, the grooves disperse the internal stress of the wood of the base plate to thereby effectively prevent the deformation of the floor board; and the periphery of the floor board is provided with male tenons 5 or female slots 6 for connecting two floor boards, and the adhesive consumption is effectively reduced by connecting the floor boards in a manner of splicing the male tenons and the female slots.

The two-layer composite wood floor board of the present invention is further illustrated with the specific processing method below.

### Embodiment 1

An oak log is chosen and peeled into a plate having the thickness of 2 mm to serve as a material for a face plate using a peeling machine, a larch log is chosen and peeled into a plate having the thickness of 10 mm to serve as a material for a base plate using the peeling machine, and a birch log is chosen and sawn into a rectangular strip of 50×8 mm; the lower surface of the base plate is grooved with a grooving machine, with each groove having the specification of 51×9 mm and the spacing between the two adjacent grooves of 20 mm; and each groove is matched with one strip; and the face plate, the base plate and the strip are bonded together with an adhesive to obtain the composite wood floor board.

### Embodiment 2

An oak log is chosen and peeled into a plate having the thickness of 2 mm to serve as a material for a face plate using a peeling machine, a larch log is chosen and peeled into a plate having the thickness of 10 mm to serve as a material for a base plate using the peeling machine, and a birch log is chosen and sawn into a rectangular strip of 40×6 mm; the lower surface of the base plate is grooved with a grooving machine, with each groove having the specification of 41×7 mm and the spacing between the two adjacent grooves of 15 mm; and each groove is matched with one strip; and the face plate, the base plate and the strip are bonded together with an adhesive to obtain the composite wood floor board.

### Embodiment 3

An oak log is chosen and peeled into a plate having the thickness of 2 mm to serve as a material for a face plate using a peeling machine, a larch log is chosen and peeled into a plate having the thickness of 10 mm to serve as a material for a base plate using the peeling machine, and a birch log is chosen and sawn into a rectangular strip of 30×5 mm; the lower surface of the base plate is grooved with a grooving machine, with each groove having the specification of 31×6 mm and the spacing between the two adjacent grooves of 10 mm; and each groove is matched with one strip; and the face plate, the base plate and the strip are bonded together with an adhesive to obtain the composite wood floor board.

### Embodiment 4

An oak log is chosen and peeled into a plate having the thickness of 2 mm to serve as a material for a face plate using a peeling machine, a larch log is chosen and peeled into a plate having the thickness of 10 mm to serve as a material for a base plate using the peeling machine, and a birch log is chosen and sawn into a rectangular strip of 20×4 mm; the lower surface of the base plate is grooved with a grooving machine, with each groove having the specification of 21×5 mm and the spacing between the two adjacent grooves of 8 mm; and each groove is matched with one strip; and the face plate, the base plate and the strip are bonded together with an adhesive to obtain the composite wood floor board.

### Embodiment 5

An oak log is chosen and peeled into a plate having the thickness of 2 mm to serve as a material for a face plate using a peeling machine, a larch log is chosen and peeled into a plate having the thickness of 10 mm to serve as a material for a base plate using the peeling machine, and a birch log is chosen and sawn into a rectangular strip of 10×2 mm; the lower surface of the base plate is grooved with a grooving machine, with each groove having the specification of 11×3 mm and the spacing between the two adjacent grooves of 5 mm; and each groove is matched with one strip; and the face plate, the base plate and the strip are bonded together with an adhesive to obtain the composite wood floor board.

### Comparative Example 1

An oak log is chosen and peeled into a plate having the thickness of 2 mm to serve as a face plate using a peeling machine, a larch log is chosen and peeled into a plate having the thickness of 10 mm and the width of 10 cm to serve as a raw material for a base plate using the peeling machine, the raw material for the base plate is bonded together with an adhesive at first, and then, the face plate and the base plate are bonded together to obtain the composite wood floor board.

TABLE 1
Data of Two-layer Composite Wood Floor board

| Data of | Em- | Em- | Em- | Em- | Em- | Compar- |
|---|---|---|---|---|---|---|
| each floor | bodi- | bodi- | bodi- | bodi- | bodi- | ative |
| board | ment 1 | ment 2 | ment 3 | ment 4 | ment 5 | Example 1 |
| Adhesive | 200 | 210 | 218 | 226 | 231 | 1500 |
| Usage | | | | | | |
| (g/m2) | | | | | | |
| Static | 28.1 | 30.2 | 31.5 | 32.4 | 33.6 | \ |
| Bending | | | | | | |
| Intensity | | | | | | |
| Elasticity | 2260 | 2275 | 2296 | 2315 | 2364 | \ |
| Modulus | | | | | | |
| (MPa) | | | | | | |

In Table 1, the static bending intensity and the elastic modulus are measured according to LY/T1738-2008, and the adhesive consumption is obtained according to the actual consumption. From Table 1, it is clear to see that the two-layer composite solid wood floor board produced with the method provided by the present invention has the adhesive consumption of below 300 g/m², the static bending intensity of about 30 MPa, and the elastic modulus of about 2230 MPa. Compared with the comparative example, the adhesive consumption of the two-layer composite solid wood floor board provided by the present invention is greatly reduced, and the strength and the rigidity of the same can be controlled via the grooves and the strips.

The description above is only directed to the preferred embodiments of the present invention, but not intended to limit the present invention. Any tiny modifications, equivalent substitutions, and improvements made to the above embodiments based on the technical essence of the present invention are construed to be incorporated in the protection scope of the technical solution of the present invention.

1. A two-layer composite wood floor board comprising:
a face plate;
a base plate, wherein the base plate is located below the face plate and connected to the face plate by an adhesive;
a plurality of grooves located in a lower surface of the base plate; and
a plurality of reinforcing ribs configured to disposed in the plurality of grooves.

2. The two-layer composite wood floor board according to claim 1, wherein the thickness of the face plate is less than the thickness of the base plate.

3. The two-layer composite wood floor board according to claim 1, wherein the thickness of the face plate is in a range of 1 mm to 6 mm and the thickness of the base plate is in a range of 9 mm to 13 mm.

4. (canceled)

5. (canceled)

6. The two-layer composite wood floor board according to claim 1, wherein a lower surface of each reinforcing rib is not less than the lower surface of the base plate.

7. The two-layer composite wood floor board according to claim 1, wherein when there are at least two grooves in the base plate, the grooves are arranged in a parallel orientation, and the spacing between each groove is in a range of 5 mm to 20 mm.

8. The two-layer composite wood floor board according to claim 1, wherein each groove possesses a width in a range of 10 mm to 50 mm and a depth in a range of 2 mm to 8 mm.

9. The two-layer composite wood floor board according to claim 1, wherein the face plate has a wood fiber direction in a vertical orientation in relation to a wood fiber direction of the base plate.

10. The two-layer composite wood floor board according to claim 1, wherein the base plate further comprises a male tenon and a female slot to allow for the connection of adjacent floor boards.
